(19) United States
(12) Patent Application Publication
(10) Pub. No.: US 2012/0074285 A1
(43) Pub. Date: Mar. 29, 2012

(54) SYSTEM AND KIT FOR ADJUSTABLY MOUNTING AN ARTICLE

(75) Inventors: Kyle Bigras, Nepean (CA); Art Ivantchouk, Carp (CA)

(73) Assignee: Fabrack Solar Inc., Carleton Place (CA)

(21) Appl. No.: 13/107,719

(22) Filed: May 13, 2011

(30) Foreign Application Priority Data
Sep. 24, 2010 (CA) 2,715,754

(51) Int. Cl. F16M 13/00

(52) U.S. Cl. 248/288.11

(57) ABSTRACT

Ground and roof mounting systems for mounting an article, such as a photovoltaic panel, comprise an adjustment assembly for easily changing the position of the article by adjusting a handle which is pivotally connected to a panel support holding the article. The roof mounting system is securable to the roof without penetrating the roof substructure.

### FIELD OF THE INVENTION

The present invention relates to mounting systems and related kits. More specifically, the present invention relates to systems and kits for mounting an article, such as a photovoltaic panel.

### BACKGROUND OF THE INVENTION

Certain articles that are routinely mounted onto a structure, such as billboards and photovoltaic panels, can benefit from the ability to be adjusted in response to various factors.

For example, billboards are often situated roadside to appeal to oncoming motorists. If, for example, the billboard is moved to a different location, based upon the nature of the terrain, the angle of inclination of the billboard may need to be adjusted to increase its visibility to the target audience. Additionally, as billboards are constantly exposed to the elements, adjustments may be needed to decrease wind resistance and/or to diminish direct exposure to harsh conditions.

Also, photovoltaic panels, which are often used as components in a larger photovoltaic system to convert sunlight to electricity for commercial and residential applications, are often mounted in order to be appropriately positioned toward the sun. In order to optimize electricity generation, the panels are mounted in locations that historically have sun exposure, and specifically pointed in the direction that captures the most sun, which is typically true south in the Northern Hemisphere, and true north in the Southern Hemisphere. Since the position of the sun changes during the day and according to the season, often the position of the photovoltaic panels is adjusted to capture maximum sunlight. In depth evaluation of sun position and corresponding adjustment to the angle of inclination of the photovoltaic panels can gain further efficiency of electricity generation.

Photovoltaic panel mounts are typically fixed, adjustable, or are tracking capable. The fixed mount is the simplest and least expensive, and in such a system, the photovoltaic panels are completely stationary. The lack of ability to adjust the panels in response to the movement of the sun or the change of seasons results in the least efficient system. Tracking mounts can be elaborate and are typically the most expensive. This type of mount is often capable of following the path of the sun during the day and across the seasons in order to maximize the amount of solar radiation that the panels receive. An adjustable mount allows for the angle of inclination (or tilt) of the photovoltaic panels to be adjusted, manually or otherwise, and can be relatively simplistic or quite complex. Accordingly, the price of such adjustable mounting systems varies, and their level of efficiency in capturing the sun's energy often falls between that of the fixed mount and the tracking mount systems.

Such photovoltaic systems are typically used for on- or off-grid applications. In an off-grid application, the generated electricity is typically consumed by the user to meet some or all of their electricity requirements.

In an on-grid application, the user enters into an agreement with a regulating government authority or power company resulting in a connection between the user's photovoltaic system and the local electricity grid, thereby allowing for the photovoltaic system's generated power to flow into the grid. In return, the user typically receives a set fee for each kilowatt-hour or other unit of electricity, that is transferred to the grid. This type of arrangement has provided a revenue generating venture for both the individual homeowner as well as for businesses.

In either the on- or off-grid application, the user is intent on maximizing their Return on Investment, by maximizing the ratio between the amount of generated electricity versus the cost to install and operate the system. This often leads to the selection of adjustable mount systems, due to their typical increased efficiency over fixed mount systems, and inexpensive cost relative to tracking systems.

However, known versions of adjustable mounting systems are often limited in the number of positions that are offered. This will ultimately decrease the amount of time the photovoltaic panels spend in optimal positions, which negatively impacts the amount of generated electricity. For example, a system may only offer two possible positions that correspond with predetermined inclination angles; however, these angles may not be sufficient to meet the needs of the user.

Furthermore, a limited number of predetermined angles would not provide the manufacturer with the flexibility to produce and sell the same mounting system across various locations, such as for example, the southern United States of America and northern Canada. The disparity in latitudes between these two locations would call for considerably different optimal angles of inclination for the photovoltaic panel systems, which a mounting system with a limited range would not be able to accommodate.

Finally, by virtue of their materials and sheer size, mounting systems are often quite heavy. Accordingly, prior art mounting systems that are adjusted manually, such as by pushing or lifting movements, often require extensive strength and effort to actuate and operate, making it difficult for an individual to change the angle of inclination.

For example, the company iSolara Solar Power, which is located in Ottawa, Canada, offers a mounting system entitled Quick-Track™. The angle of inclination of the mounted article in the Quick-Track™ mounting system is limited to two positions, and the adjustment of this system occurs via a pushing or lifting movement.

In addition, certain systems are mounted on substructures, such as flat or inclined roofs. Prior art systems are typically fixed directly to the top of the substructure such as by bolts or nails at the base of the system, which compromise the substructure's watertight feature, thereby increasing the likelihood of substructure damage and repair costs. There is a need to couple systems to structures without the need to penetrate the substructure at the base of the system or otherwise compromise the substructure's integrity.

### SUMMARY OF THE INVENTION

It is an object of the present invention to provide an adjustable mounting system that addresses some or all of the deficiencies found in the prior art.

According to one aspect of the present invention, there is provided a system for adjustably mounting an article, comprising a base; a skyward facing panel support pivotally attached to the base; and an adjustment assembly connecting the panel support and the base; wherein manipulation of the adjustment assembly causes the panel support to move about the base.

### BRIEF DESCRIPTION OF THE DRAWING

The present invention will now be described in greater detail with reference to the drawings in which:

FIG. 1 is a perspective view of a ground mounted embodiment of the present invention, where the panel support has been adjusted at 126 to an angle of inclination greater than 45°.

FIG. 2 is a perspective view of a ground mounted embodiment of the present invention, where the panel support has been adjusted at 126 to an angle of inclination of about 45°.

FIG. 3 is a perspective view of a ground mounted embodiment of the present invention, where the panel support has been adjusted at 126 to an angle of inclination less than 45°.

FIG. 4 is a schematic representation of a roof mounted embodiment of the present invention, depicting a plurality of systems located adjacent to each other and connected with a common attachment means.

FIG. 5 is a perspective view of a roof mounted embodiment of the present invention.

FIG. 6 is a partial side elevation view of a roof mounted embodiment of the present invention, depicting two adjacent systems and a coupling post.

FIG. 7 is a close-up view from FIG. 4 of one embodiment of a connector in accordance with the present invention.

FIG. 8 is a close-up view from FIG. 4 of one embodiment of a parapet connection in accordance with the present invention.

FIG. 9 is a close-up side view of a coupling post base mounted on a framing channel in accordance with one embodiment of the present invention.

FIG. 10 is a close-up top view of a securing assembly comprising a coupling post, cable and cable clips in accordance with one embodiment of the present invention.

### DETAILED DESCRIPTION OF THE INVENTION

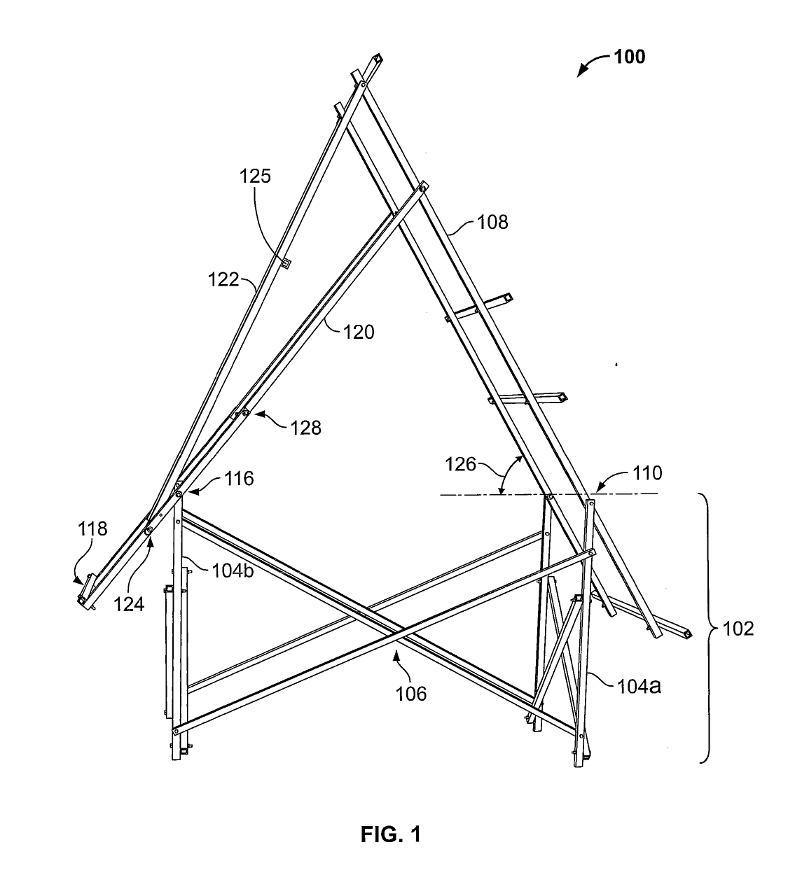

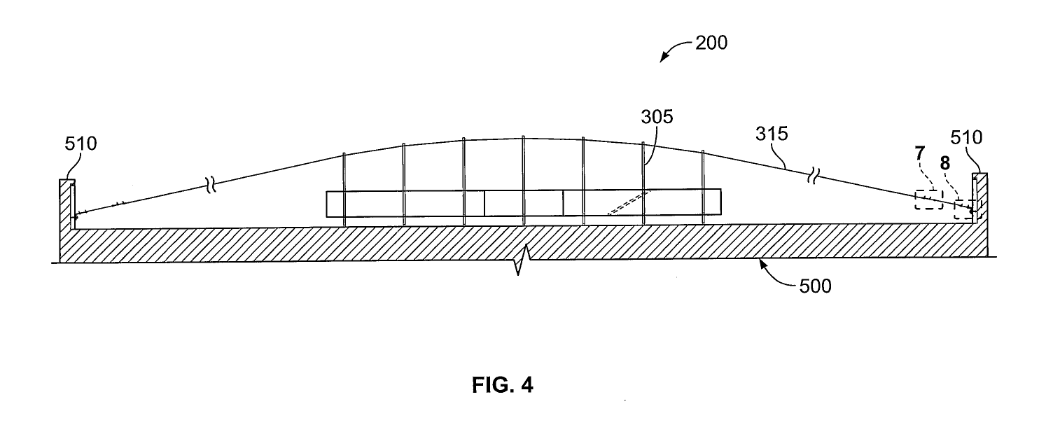

As used throughout the specification, “ground mounted system” generally refers to embodiments illustrated in FIGS. 1-3 and “roof mounted system” generally refers to embodiments illustrated in FIGS. 4-10.

Ground mounted has a broad meaning and is not limited to systems that must be mounted on the ground. Ground mounted systems can be mounted anywhere, including on the ground, where the system's base, as defined below, can be stabilized, such as within concrete posts.

Roof mounted also has a broad meaning and is not limited to systems that must be mounted on a building roof. Roof mounted systems can be mounted on any substructure, including on a roof, where the system's coupling posts, as defined below, can be secured with attachment means to an underlying structure, as described below.

One embodiment of the present invention is an adjustable mounting system 100 illustrated in FIGS. 1-3. The adjustable mounting system 100 comprises a base 102 that serves to stabilize the structure. The embodiment of the base 102 as illustrated has front vertical base members 104a, and back vertical base members 104b situated at the front and rear of the adjustable mounting system 100, respectively. The number of vertical base members 104a, 104b is dependent upon the width of the adjustable mounting system 100. Typically four vertical base members 104a, 104b situated at the corners of the base 102 are sufficient; however, other embodiments are contemplated where the adjustable mounting system 100 is constructed at a size that requires six, eight, ten etc. vertical base members 104a, 104b, with the additional vertical base members 104a, 104b spaced along the length of the base 102. The illustrated embodiment depicts the front and back vertical base members 104a, 104b as having the same height; however, they may be of differing heights.

Optionally, cross beams 106 are placed between the vertical base members 104a, 104b to provide further support and strengthen the base 102. The embodiment shown in FIGS. 1-3 illustrate the cross beams 106 in an X-pattern, however, the cross beams 106 can also extend between the vertical base members 104a, 104b in a horizontal fashion, such as along the top, bottom or middle of the vertical base members 104a, 104b. In another embodiment, a unitary beam extends along the perimeter of the base 102 to provide additional support and preset mounting positions.

In this embodiment, the base 102 primarily serves the function of supporting the remainder of the structure while also providing rotatable connection points to the adjustable portions of the mounting system 100. Accordingly, types or styles of bases 102 other than the scaffold-type as illustrated in FIGS. 1-3 are contemplated, provided that they are able to serve these functions. For example, the base 102 may be a unitary solid square or rectangular shaped structure, whereas in another embodiment, the base 102 comprises a pole with a platform-type structure mounted thereon.

The adjustable mounting system 100 comprises a panel support 108, which serves as the point of attachment for the mounted article, not shown. According to one embodiment, the panel support 108 comprises a combination of support members, such as metal tubing, that are arranged in vertical, horizontal and/or diagonal positions to form, e.g. a lattice or grid pattern. The exact orientation of the support members is not limiting, however, the support members are of a number and in an arrangement such that they are able to provide sufficient support to the mounted article. The nature of the mounted article is also taken into consideration. For example, if the adjustable mounting system is for a pre-fabricated photovoltaic panel, at least a portion of the panel support 108 will need to correspond with the attachment points available on the photovoltaic panel or other attachment mechanism disposed therebetween, such that the mounted article is sufficiently retained and fastened to the panel support 108 of the mounting system 100.

As the panel support 108 serves as the attachment/connection point between the mounted article, such as a photovoltaic panel, and the adjustable mounting system 100, various additional designs and structures of the panel support 108 are contemplated aside from the scaffold-type constructions as illustrated in FIGS. 1-3, provided that these additional embodiments can adequately carry out these functions. For example, in another embodiment, the panel support 108 is of a flat, planar, unitary construction, and may have the dimensions of the article to be mounted, or may be substantially smaller and attach to the middle of the mounted article.

As can be seen in FIG. 1, the front portion of a panel support 108 is pivotally connected to the front portion of the base 102 by, for example, a panel hinge 110. For example, the illustrated embodiment shows the panel support 108 pivotally connected to the front vertical base members 104a at panel hinge 110. In another embodiment, not illustrated, the panel support 108 is pivotally connected to a cross beam 106 that extends between the top of the front vertical base members 104a. When the angle of inclination 126 of the panel support 108 is adjusted through an adjustment assembly 112, it pivots about panel hinge 110.

In one embodiment, the article to be mounted, such as a photovoltaic panel, is attached to the panel support 108 through the use of fasteners. The article may also be a billboard or other article that requires mounting in accordance with the present invention. For example, the rear side of a pre-fabricated photovoltaic panel will typically have pre-defined connection points. The panel support 108 has corresponding connection points to allow fasteners, such as screws, bolts, brackets etc., to secure the photovoltaic panel to the panel support 108. However, it is to be understood that the exact nature of how the article is secured to the panel support 108 is typically dependent upon the specific features of the article, such as pre-existing connection points.

The adjustment of the angle of inclination 126 of the support panel 108 occurs via the actions of an adjustment assembly 112. In the embodiment as illustrated in FIGS. 1-3, the adjustment assembly 112 comprises a swing arm 114, a connector arm 120 and a locking arm 122.

The adjustable mounting system 100 of this embodiment may contain a single adjustment assembly 112, provided that one assembly 112 is sufficient to operably adjust the panel support 108 and the mounted article. In such an embodiment, the adjustment assembly 112 might optimally be situated in the middle of the panel support 108. If the size of the adjustable mounting system 100 dictates, embodiments are envisioned that have a plurality of adjustment assemblies 112 arranged along the length thereof. Typically an adjustment assembly 112 is situated at each edge of the panel support 108 to provide stability, with additional adjustment assemblies 112 dispersed throughout the middle of the panel support as required. The adjustment assemblies 112 may be interconnected by, e.g. lateral members, such that they act in unison, or alternatively, each adjustment assembly 112 operates independently of the others.

A swing arm 114 is pivotally connected to the upper portion of the back of the base 102 as shown in FIGS. 1-3. For example, the illustrated embodiment has the swing arm 114 pivotally connected to a back vertical base member 104b at connection 116, whereas in another embodiment, not illustrated, the swing arm 114 is pivotally connected to a cross beam 106 that extends between the top of the back vertical base members 104b.

Optionally, a first end of the swing arm 114 has a handle 118 to aid a user to manipulate the adjustment assembly 112 as described herein. In the case of a single adjustment assembly 112, a simple handle 118 such as a T-handle is envisioned, whereas in the case of a plurality of adjustment assemblies 112, a continuous handle 118 that connects and consolidates some or all of the swing arms 114 of the a plurality of systems 100 can be configured accordingly. The swing arm 114 effectively produces a simple lever, where the base 102, by virtue of its pivotable connection to the swing arm 114, acts as a fulcrum. The effort is applied to a first end of the swing arm 114, and the load (the panel support 108 with or without a mounted article) is picked up through a connector arm 120 pivotally connected to the second end of the swing arm 114.

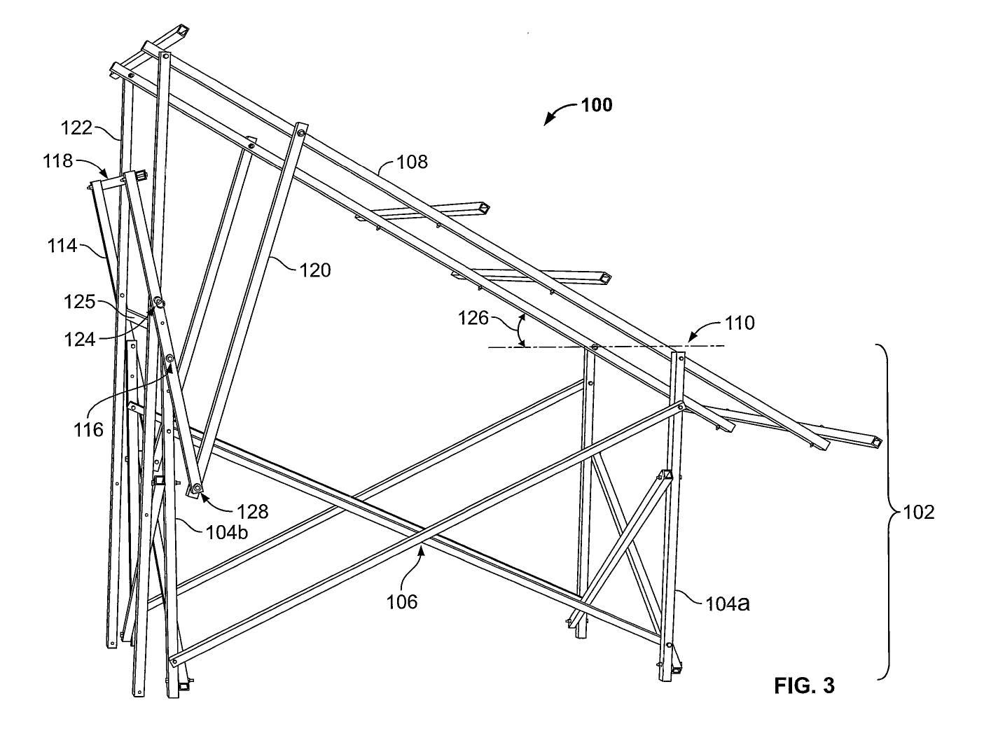

One end of the connector arm 120 is rotatably attached to the support panel 108, while the opposing end is rotatably attached to the swing arm 114 at locking pin 128. When the handle 118 of the swing arm 114 is raised or lowered, the angle of inclination 126 of the support panel 108, through the associated movement of the connector arm 120, is decreased as shown in FIG. 3, or increased as shown in FIG. 1, respectively.

The adjustment assembly also comprises a locking arm 122, best illustrated in FIG. 3. In the illustrated embodiment, locking arm 122 comprises two parallel arms secured by stabilizer bar 125. The locking arm 122 is rotatably connected to the rear portion of the panel support 108, such as through a hinge, and serves to lock the panel support 108 in various positions. The locking arm 122 moves freely from the rear portion of the panel support 108. When the swing arm 114 and connector arm 120 have placed the panel support 108 in its desired position, the locking arm 122 is attached to the swing arm 114, effectively securing the adjustment assembly 112 and the panel support 108 in a locked position.

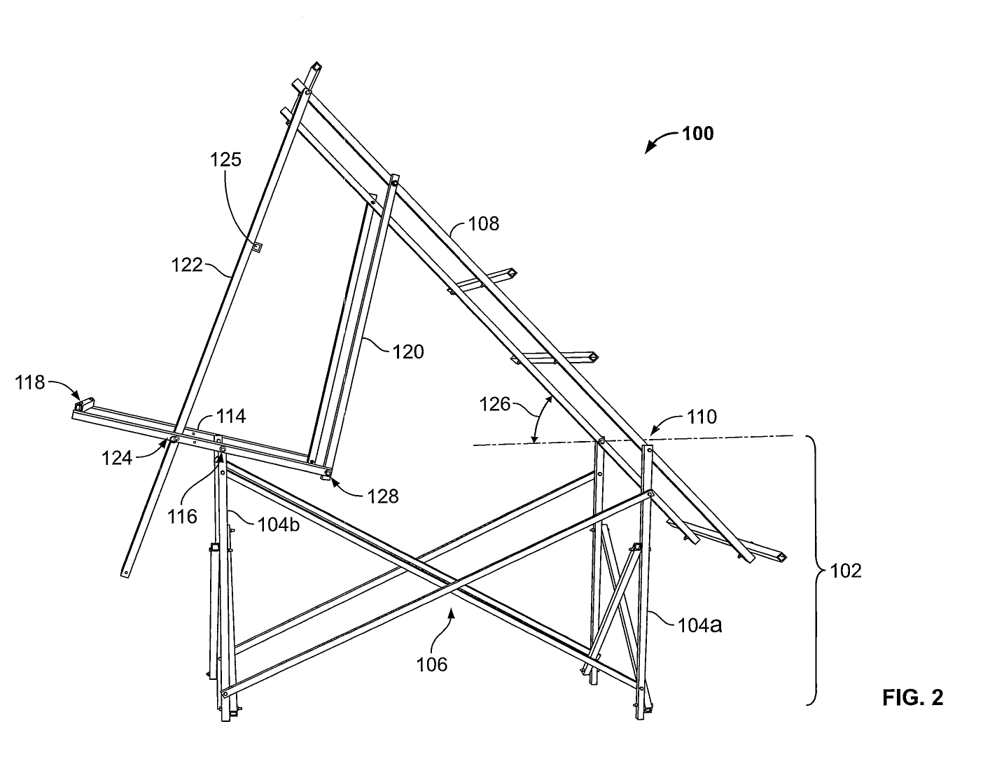

In one embodiment, the swing arm 114 and the locking arm 122 have securing means 124 such as ⅜″×4″ stainless steel bolt with nylock nut, that when utilized, are able to lock the panel support 108 at certain predetermined angles of inclination 126, such as an angle less than 45° (eg: 30°), 45° and an angle greater than 45° (eg: 60°). FIG. 1 illustrates an embodiment of the invention where the angle of inclination 126 of the panel support 108 is 60°. FIG. 2 illustrates an embodiment where the angle of inclination 126 is 45°. FIG. 3 illustrates an embodiment where the angle of inclination 126 is 30°. Other angles of inclination 126 are contemplated, such that the system 100 can be mounted in various conditions. For example, if the article is a photovoltaic panel, the latitude of the area where the system 100 is used will be a primary factor in determining optimum angles of inclination.

Additionally, fastening members may be required to secure the locking arm 122 to the swing arm 114. For example, in one embodiment, the swing arm 114 and locking arm 122 have a certain number of pre-drilled holes along their lengths. The pre-drilled holes correspond with desired angles of inclination 126 of the support panel 108. When the swing arm 114 has been manipulated to place the panel support 108 in the desired position, the locking arm 122 is brought into contact with the swing arm 114. At the point of contact, a pre-drilled hole in the locking arm 122 will align with a pre-drilled hole in the swing arm 114, and a fastening member, such as a screw or a pin, is inserted to secure the connection.

In another embodiment, not illustrated, the adjustment assembly 112 does not comprise a locking arm 122. Rather, alternative means for securing the panel support 108 at certain predetermined positions is contemplated. For example, a slotted plate that attaches to the leg allows locking of the swing arm in unlimited positions. According to one embodiment, the movement of the adjustment assembly 112 is mechanically actuated, and therefore, the machinery is able to lock and retain the panel support 108 at the desired angle of inclination 126.

When placed in its desired location, the adjustable mounting system 100 is typically secured to the ground. If the adjustable mounting system 100 is positioned on a solid ground surface, such as metal or concrete, it can be secured by fastening means known in the art, such as welding, screwing, latching, strapping etc. In such an embodiment, the bottom of the vertical base members 104a, 104b can have foot members or pads, not illustrated.

When the adjustable mounting system 100 is destined to be situated on earth, such as in a field or a yard, one embodiment of the system 100 has extended vertical base members 104a, 104b. The extensions of the vertical base members 104a, 104b allow a portion of the base 102 to be sunk into the ground. This process is akin to sinking a fence post in the ground, and is known to one of skill in the art. Often, various strengthening agents, such as concrete or stones, are deposited into the ground with the vertical base members 104a, 104b, in order to strengthen and stabilize the connection with the ground.

The materials that comprise the adjustable mounting system 100 are not to be considered limiting. It is contemplated that the components of the adjustable mounting system 100 are made from a lightweight metal, such as aluminum, however, other materials, such as steel or plastics may be used provided that they have the strength to support the article that is to be mounted.

According to a further ground mounted embodiment, at least one of the components of the adjustable mounting system 100, such as the components, i.e. support members, of the panel support 108, are extruded with a hollow cavity or channel extending along at least a portion thereof. For example, the inclusion of an extruded channel, such as a T-slot or a similar type channel, in the support members of the panel support 108, combined with the use of fasteners that are adapted to be received by the channel, constitutes a universal connection for the articles that can be mounted by a given assembly 100.

Similarly, in another embodiment, an extruded channel, such as a T-slot or a similar type channel, is included in the swing arm 114 and/or the locking arm 122. When combined with the use of fasteners that are adapted to be received by the channel, the angle of inclination 126 of the support panel 108 can be adjusted and set precisely as desired, and then subsequently locked in at that position, as opposed to being limited to a few predetermined angles.

According to a further embodiment, the adjustment assembly 112 comprises one swing arm 114, and a plurality of connector arms 120. In this embodiment, the swing arm 114 is pivotally connected to the upper portion of the back of the base 102 as shown in FIGS. 1-3, typically in a centralized location with respect to the panel support 108. An end of each of the plurality of connector arms 120 is rotatably attached to the same swing arm 114. The opposing ends of the plurality of connector arms 120 are rotatably connected to the support panel 108, such as in a splayed manner. For example, a first connector arm 120 extends to and connects at the left edge of the panel support 108; a second connector arm 120 extends to and connects at the central portion of the panel support 108; and a third connector arm extends to and connects at the right edge of the panel support 108.

Additionally, the shape of the components of the adjustable mounting system 100, such as their cross section is not to be considered limiting. For example, the cross section of the components of the adjustable mounting system 100 may be circular, square, rectangular, oval, or any other shape.

According to another ground mounted embodiment, the adjustable mounting system 100 of the present invention is mounted on a rotatable platform. The rotation of the platform can be performed manually, although automated rotation of the platform is also contemplated. Furthermore, automation of the rotation of the platform can be computerized. In such an embodiment, not only will the angle of inclination 126 of the mounted article be capable of adjustment, but the direction the assembly 100 and therefore the mounted article faces can also be adjusted. This is particularly beneficial when a photovoltaic panel is mounted on the adjustable mounting system 100, as the photovoltaic panel will be able to track the sun across the sky, increasing the capture of the sun's radiation and the overall efficiency of the system.

In another embodiment, the handle 118 on the adjustable mounting assembly 100 is equipped with a counterweight or ballast. The addition of such a counterweight to the handle 118 decreases the resistance a user encounters when trying to manipulate the angle of inclination 126 of the panel support 108 through actuation of the adjustment assembly 112. According to another embodiment, the adjustable mounting assembly 100 comprises a lift support to aid in the adjustment of the angle of inclination 126 of the panel support 108. For example, struts connecting the panel support 108 and the base 102 alleviate some of the force required to adjust the panel 108.

According to a roof mounted embodiment of the present invention, the adjustable mounting assembly 100 as described above is adapted for installation on substructures including rooftops, preferably on flat roofs. Roof mounted embodiments of the adjustable mounting assembly 100 as described above typically have smaller dimensions than their ground-mounted counterparts to compensate for such factors as limited space on a roof, and harsh weather conditions (e.g. snow, wind) at higher elevation. For example, the vertical base members 104a, 104b of the roof-mounted embodiments of the adjustable mounted assembly 100 are shortened to minimize the extension of the assembly above the rooftop. Although, the base 102 must still be of a size to allow the adjustment assembly 112 to rotate, thereby adjusting the panel support 108 through its predetermined angles of inclination 126.

The adjustable mounting assembly 100 can be secured to the substructure in a variety of known ways, such as through welding or the use of fastening members (e.g. clamps, seam clamps, screws, nails etc.). In many cases, however, it is not desirable to pierce the substructure as the integrity of the substructure is impacted.

As such, in accordance with another embodiment of the present invention, shown in FIGS. 4-10, there is provided one or more mounting assemblies 300 which are secured to the substructure 500 without piercing the top of the substructure 500

FIG. 4 depicts a series 200 of systems 300 located adjacent to each other and connected with a common attachment means 315 and coupling posts 305 of different heights, depending on the number of systems 300. The systems 300 rest on, but are not attached to the top of the substructure 500. The length of the attachment means 315 depends on the width of the substructure 500. The raised end walls or parapets 510 of the substructure 500 are typically perpendicular to the top of the substructure 500.

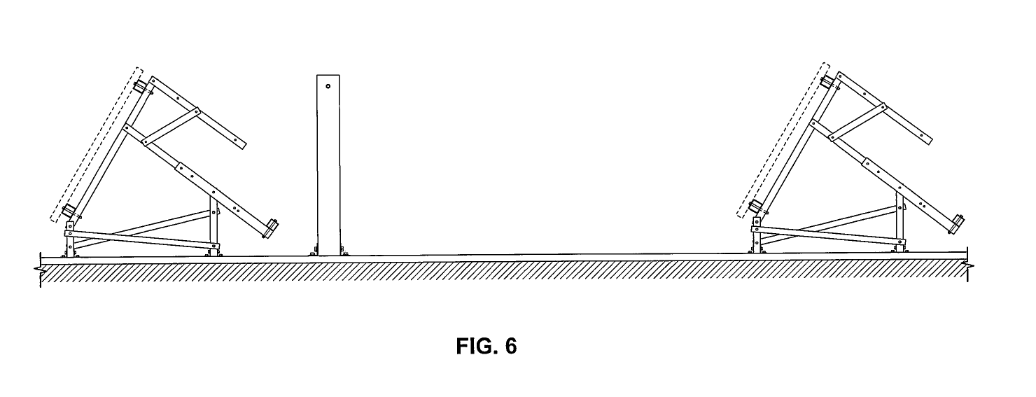

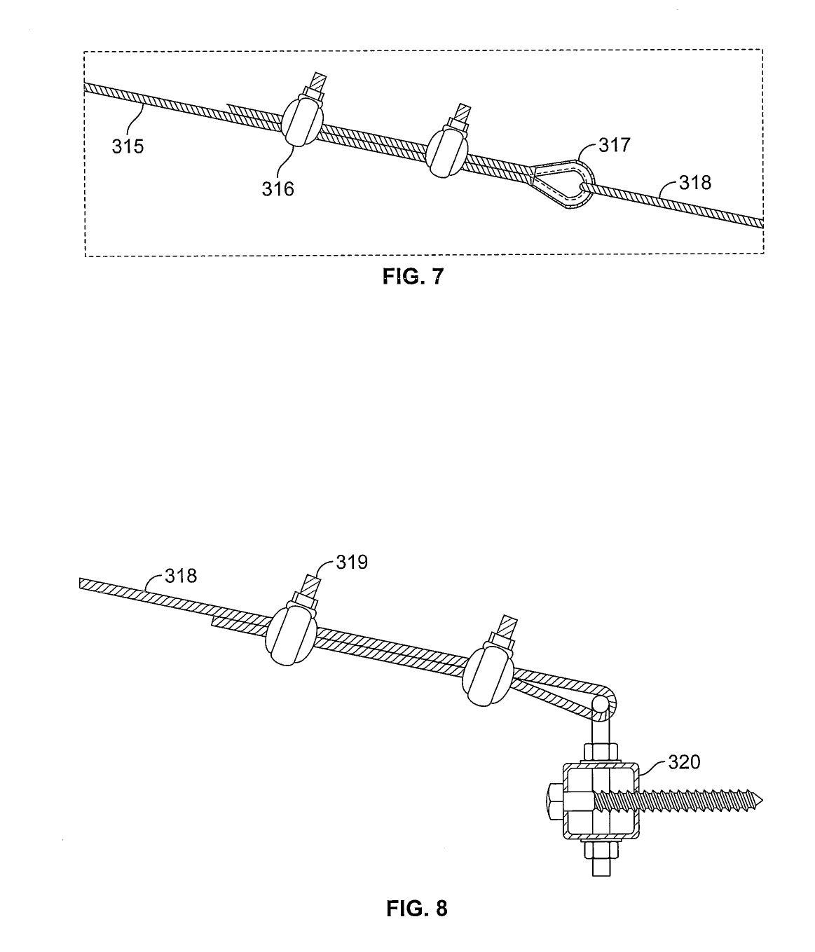

Parapet connections are secured to studs in the parapets 510. Close-up views of one embodiment of the connectors 7 and parapet connections 8 in FIG. 4 are depicted in FIGS. 7 and 8, respectively, further described below.

FIG. 5 is perspective view of a roof mounted embodiment of the present invention. System 300 is sitting on the top of substructure 500, but it is not attached to it with screws or other piercing attachments.

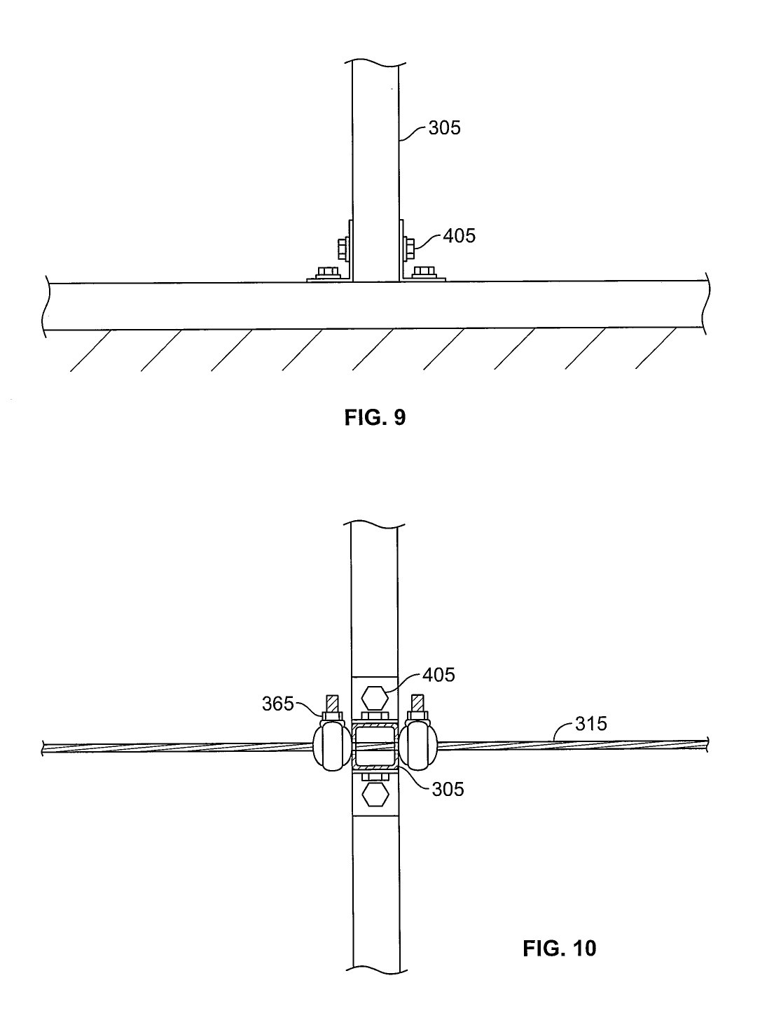

Panel support 335 is configured to support an article, not illustrated, such as a billboard or photovoltaic panel. Adjustable or fixed mounting structures may be used in accordance with this embodiment of the invention. Adjustable assemblies, similar to those described above and illustrated in FIGS. 1-3 may be used, although base 102 from system 100 is replaced with mounts 405, further illustrated in FIG. 9. The base of coupling post 305 and front and rear legs 330 are mounted on to framing channel 310 with mounts 405 such as with bolts. As depicted in FIG. 10, at the top of coupling posts 305 is a securing assembly, comprising coupling post 305, attachment means 315 and clips 365. Attachment means can include cable, such as ¼ inch steel cable, chain, rope or other suitable mechanism which can attach coupling posts 305 to parapets 510.

System 300 comprises a base, having a front portion and a rear portion. The base sits on the top of substrate 500 and is therefore parallel to the horizontal plane of the substructure. A skyward facing panel support 335 is attached to the front portion of the base with post 330. An assembly connects the panel support 335 and the base. One or more coupling posts 305 are attached to the base proximate the rear portion of the base and extend about perpendicularly outwardly therefrom. Attachment means 315 such as steel cable attach the one or more coupling posts to the substructure's parapets, thereby securing system 300 to the substructure's horizontal plane without piercing the substructure.

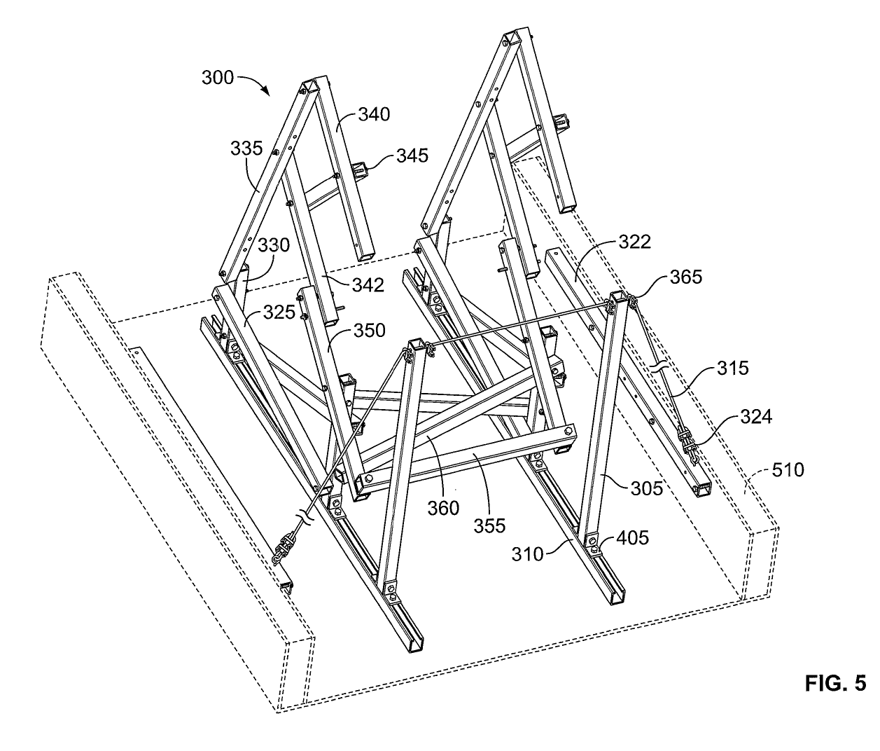

FIG. 6 illustrates one embodiment of the present invention depicting two adjacent systems and a coupling post secured to a base, such as plywood which sits on top of the substructure. The base is not attached to the substructure. The coupling post in this embodiment, which can be made of aluminum or other suitable material, is positioned between the two systems so as to optimally maximize the tension of attachment means 315. The height of coupling post is dependent on the height of the adjacent systems. For example, FIG. 4 depicts seven coupling posts 305 wherein the outer coupling posts are relatively shorter than the central coupling post. In one embodiment, the height of the two outer coupling posts is 1455 mm, the next two coupling posts is 1680 mm, the next two coupling posts is 1790 mm and the central post is 1829 mm tall. The parabolic shape of attachment means 315 provides more tension onto the series 300 of systems.

FIG. 7 is a close-up view from FIG. 4 of one embodiment of a connector in accordance with the present invention. Attachment means, such as steel cable 315, is coupled with suitable cable clips 316 known in the art and terminate with heavy duty wire rope thimbles 317 to suit the steel cable. Within the thimble is secured more steel cable 318.

FIG. 8 is close-up view from FIG. 4 of one embodiment of a parapet connection in accordance with the present invention. Steel cable 318 further attaches with known connectors such as suitable cable clips 319 and ultimately connects to the parapet, not illustrated, with a U-bolt and nut assembly through aluminum tube 320. Tube 320 is secured to existing studs in the parapet with a lag screw in this embodiment.

The skilled worker will appreciate that the roof mounted system 300 of FIGS. 4-10 eliminates the need to pierce the top of substrate 500 yet secures system 300 or series 200 of systems 300 to the substrate 500. The top of substrate 500 is typically flat and unobstructed in a first horizontal plane, whereas the parapets 510, also typically flat and unobstructed are in a second plane, typically perpendicular to the first horizontal plane.

1. A system for adjustably mounting an article, comprising:
a base, having a front portion and a rear portion;
a skyward facing panel support pivotally attached to the front portion of the base; and
an adjustment assembly connecting the panel support and the base;
wherein manipulation of the adjustment assembly causes the panel support to move about the base.

2. The system according to claim 1, wherein the adjustment assembly comprises:
a connector arm, with a first end thereof rotatably attached to the panel support and a second end; and
a swing arm pivotally attached to the rear portion of the base, with a first end of the swing arm being pivotally attached to the second end of the connector arm.

3. The system according to claim 2, wherein the adjustment assembly further comprises a locking arm rotatably attached to an upper portion of the panel support, the locking arm being adapted to connect with and secure the swing arm.

4. The system according to claim 3, wherein the locking arm and the swing arm each have a plurality of corresponding securing means along their length, providing for securement of the adjustment assembly in a plurality of positions.

5. The system according to claim 1, wherein the panel support comprises support members arranged to form a lattice or grid pattern.

6. The system according to claim 2, wherein a second end of the swing arm comprises a handle.

7. The system according to claim 1, wherein the base comprises vertical base members.

8. The system according to claim 1, wherein the base comprises a pole with a platform mounted thereon.

9. A system for mounting an article onto a substructure having a first plane and a second plane, said system comprising:
a base, having a front portion and a rear portion, said base positioned parallel to the first plane of said structure;
a skyward facing panel support attached to the front portion of the base; and
an assembly connecting the panel support and the base;
one or more coupling posts attached to the base proximate the rear portion of the base and extending about perpendicularly therefrom; and
an attachment means for attaching said one or more coupling posts to the second plane of said structure;
thereby retaining said system against the first plane of structure.

10. The system of claim 9 wherein said attachment means is chosen from the group consisting of cable, chain or rope.

11. The system of claim 9 wherein said second plane is about perpendicular to said first plane.

12. A system for adjustably mounting an article, comprising:
a plurality of vertical base members, including at least at least two front vertical base members and at least two back vertical base members;
a plurality of cross beams for supporting the vertical base members;
a panel support pivotally supported by the front vertical base members, said panel support comprising a plurality of support members arranged to support said article; and
an adjustment assembly pivotally connected between the panel support and the back vertical base members;
wherein the adjustment assembly rotates the panel support between multiple positions.

13. The system of claim 12, wherein the multiple positions include two or more positions.

14. The system of claim 12, wherein the adjustment assembly includes a swing arm pivotally connected to the back vertical base members, and a locking arm pivotally connected to the panel support.

15. The system of claim 14, wherein the swing arm includes at least one handle.

16. The system of claim 15, wherein the at least one handle is arranged across the back vertical base members.

17. The system of claim 12, wherein locking means secures the panel support in each of the multiple positions.

18. The system of claim 12, wherein the front vertical base members and back vertical base members are of different heights.

19. The system of claim 15, wherein the angle of inclination between the panel support and the front vertical base members in a first of said multiple positions is less than the angle between the panel support and the front vertical base members in a second of said multiple positions.

20. The racking system of claim 19, wherein the handle is proximate to the locking arm in the first position, and the handle is distal to the locking arm in the second position.
